(19) United States
(12) Patent Application Publication
(10) Pub. No.: US 2009/0321397 A1
(43) Pub. Date: Dec. 31, 2009

(54) LASER-SCRIBING PLATFORM

(75) Inventors: Sriram Krishnaswami, Saratoga, CA (US); Shinichi Kurita, San Jose, CA (US); Bassam Shamoun, Fremont, CA (US); Bejamin M. Johnston, Los Gatos, CA (US); John M. White, Hayward, CA (US); Jiafa Fan, San Jose, CA (US); Inchen Huang, Fremont, CA (US)

Correspondence Address: TOWNSEND AND TOWNSEND AND CREW LLP, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 12/422,200

(22) Filed: Apr. 10, 2009

Related U.S. Application Data
(60) Provisional application No. 61/044,021, filed on Apr. 10, 2008.
(60) Provisional application No. 61/047,372, filed on Apr. 23, 2008.
(60) Provisional application No. 61/075,682, filed on Jun. 25, 2008.

(51) Int. Cl. B23K 26/38

(52) U.S. Cl. 219/121.68

(57) ABSTRACT

Laser-scribing systems and translation stages operable to support a workpiece during laser scribing are provided. A laser-scribing system includes a base section, a bed supported by the base section, a laser, a first driving mechanism operable to move a workpiece longitudinally along the bed, and a second driving mechanism. The bed comprises a movable section configured to translate with respect to the base section. The movable section comprises a gap to allow a laser beam to pass through. The laser is positioned to direct the laser beam through the gap. The second driving mechanism is operable to laterally translate the laser and the movable section in order to scribe a pattern on the workpiece.

### CROSS-REFERENCES TO RELATED APPLICATIONS

This application claims the benefit of U.S. Provisional Application Nos. 61/044,021, filed Apr. 10, 2008; 61/047,372, filed Apr. 23, 2008; and 61/075,682, filed Jun. 25, 2008, which are hereby incorporated herein by reference.

### BACKGROUND OF THE INVENTION

Many embodiments described herein relate generally to the scribing of materials, as well as systems and methods for scribing materials. These systems and methods can be particularly effective in scribing single-junction solar cells and thin-film multi-junction solar cells.

Current methods for forming thin-film solar cells involve depositing or otherwise forming a plurality of layers on a substrate, for example, a glass, metal or polymer substrate suitable to form one or more p-n junctions. An example of a solar cell has an oxide layer (e.g., a transparent conductive oxide (TCO)) deposited on a substrate, followed by an amorphous-silicon layer and a metal-back layer. Examples of materials that can be used to form solar cells, along with methods and apparatus for forming the cells, are described, for example, in co-pending U.S. patent application Ser. No. 11/671,988, filed Feb. 6, 2007, entitled “MULTI-JUNCTION SOLAR CELLS AND METHODS AND APPARATUSES FOR FORMING THE SAME,” which is hereby incorporated herein by reference. When a panel is being formed from a large substrate, a series of scribe lines is typically used within each layer to delineate the individual cells. The scribe lines are formed by laser ablating material from a workpiece, which consists of a substrate having at least one layer deposited thereon. The laser-scribing process typically occurs with the workpiece sitting supported on top of a planar stage or bed.

Laser-scribed patterns are formed on the workpiece by having relative motion between the laser beam and the workpiece. In previous approaches, this is accomplished by having the laser beam fixed and moving the workpiece. If the workpiece is held stationary on the stage or bed, then this would involve moving the stage or bed. If the workpiece has some degree of freedom to move on the stage or bed, then this would involve some combination of moving the workpiece and/or moving the stage or bed. Also, if the workpiece moves relative to a fixed laser then the bed might have to be up to four times the size of the workpiece, or the workpiece must be rotated, in order to access all areas of the workpiece. Further, under this fixed laser beam approach, the beam path from the scribing laser to the workpiece is typically long. This long fixed beam path between the laser and the workpiece raises beam convergence and stability issues. Further, the stage or bed typically consists of a single planar piece that holds the workpiece stationary and moves together with the workpiece. In order to accommodate the workpieces, which in one example can be as large as one square meter, this stage also has to be large, making it difficult to ship from the manufacturer site to the user site.

Accordingly, it is desirable to develop systems and methods that overcome at least some of these, as well as potentially other, deficiencies in existing scribing and solar panel manufacturing devices.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Systems and methods for laser scribing a workpiece and translation stages for supporting a workpiece during laser scribing are provided. Many embodiments may provide for improved control, as well as the ability to scribe in multiple directions and/or patterns without rotating the workpiece. Systems and methods in accordance with many embodiments provide for general purpose, high-throughput, direct patterning laser scribing on large film-deposited substrates. These systems and methods may be particularly effective in scribing single-junction solar cells and thin-film multi-junction solar cells.

In many embodiments, a system for scribing a workpiece is provided. The system comprises a laser operable to generate output able to remove material from at least a portion of the workpiece, a scanning device operable to control a position of the output from the laser, a translation stage operable to support the workpiece and move the workpiece along a longitudinal translation vector with respect to the scanning device, and a lateral translation mechanism operable to laterally translate the scanning device. The translation stage includes at least one stationary section and a lateral translation section. The lateral translation section of the translation stage and the scanning device are able to move in a coordinated lateral

In many embodiments, a translation stage operable to support a workpiece during laser scribing is provided. The translation stage comprises a base section and a bed supported by the base section. The bed comprises a translatable central section configured to translate laterally with respect to the base section. The translatable central section comprises at least one gap to allow a laser beam to pass through. The translatable central section is positioned higher than a remaining portion of the bed such that any workpiece translated longitudinally on the bed will not damage a leading edge of the workpiece when translating from the translatable central section, at least a portion of the workpiece remaining on the translatable central section during longitudinal translation.

In many embodiments, a laser-scribing system is provided. The laser-scribing system includes a base section, a bed supported by the base section, a laser, a first driving mechanism operable to move a workpiece longitudinally along the bed, and a second driving mechanism. The bed comprises a translatable central section configured to translate laterally with respect to the base section. The translatable central section comprises at least one gap to allow a laser beam to pass through. The laser beam is configured to be directed through the gap. The second driving mechanism is operable to laterally translate the laser and the translatable central section in order to scribe a pattern on the workpiece.

### BRIEF DESCRIPTION OF THE DRAWINGS

A further understanding of the nature and advantages of the invention may be realized by reference to the remaining portions of the specification and the drawings wherein like reference numerals are used throughout the several drawings to refer to similar components. The Figures are incorporated into the detailed description portion of the invention.

FIG. 1 illustrates laser-scribed lines in a thin-film solar-cell assembly.

FIG. 2 illustrates a perspective view of a laser-scribing system in accordance with many embodiments.

FIG. 3 illustrates a side view of a laser-scribing system in accordance with many embodiments.

FIG. 4 illustrates an end view of a laser-scribing system in accordance with many embodiments.

FIG. 5 illustrates a top view of a laser-scribing system in accordance with many embodiments.

FIG. 6 illustrates a set of laser assemblies in accordance with many embodiments.

FIG. 7 illustrates components of a laser assembly in accordance with many embodiments.

FIG. 8 illustrates the generation of multiple scan areas in accordance with many embodiments.

FIG. 9 diagrammatically illustrates the integration of a camera within a laser-scanning assembly in accordance with many embodiments.

FIG. 10A illustrates a method for scribing parallel to the movement direction of a workpiece in accordance with many embodiments.

FIG. 10B illustrates another method for scribing parallel to the movement direction of a workpiece in accordance with many embodiments.

FIG. 11A illustrates a method for scribing perpendicular to the movement direction of a workpiece in accordance with many embodiments.

FIG. 11B illustrates another method for scribing perpendicular to the movement direction of a workpiece in accordance with many embodiments.

FIG. 12 illustrates the use of line sensing optics to align the formation of a laser-scribed line with a previously formed laser-scribed line in accordance with many embodiments.

FIG. 13 illustrates the use of a beam viewer to measure the position of a laser beam in accordance with many embodiments.

FIG. 14 illustrates stages that can be used to move a workpiece and scribing system components in accordance with many embodiments.

FIG. 15 illustrates workpiece motion with yaw and straightness correction in accordance with many embodiments.

FIGS. 16A and 16B illustrate top views of a “three section” planar stage or bed that can be used in accordance with many embodiments.

FIGS. 17A-17D illustrate different cross-sectional views of a “three section” planar stage or bed (shown in FIGS. 16A-16B) that can be used in accordance with many embodiments: FIG. 17A illustrates the Section 1-1 cross-sectional view, FIG. 17B illustrates the Section 2-2 cross-sectional view, FIG. 17C illustrates the Section 3-3 cross-sectional view, FIG. 7D illustrates the Section 4-4 cross-sectional view.

FIGS. 18A-18B illustrate the extreme positions of the workpiece over a “three section” planar stage or bed (shown in FIGS. 16A-16B) along the Y-direction in accordance with many embodiments.

FIGS. 19A-19B illustrate the extreme positions of the movable center section of the “three section” planar stage or bed (shown in FIGS. 16A-16B) along the X-direction in accordance with many embodiments.

### DETAILED DESCRIPTION OF THE INVENTION

Systems and methods in accordance with many embodiments of the present disclosure can overcome one or more of the aforementioned and other deficiencies in existing scribing approaches. Many embodiments can provide for improved control, as well as the ability to scribe in multiple directions and/or patterns without rotating the substrate. Systems and methods in accordance with many embodiments provide for general purpose, high-throughput, direct patterning laser scribing on large film-deposited substrates. Such systems and methods allow for bi-directional scribing, patterned scribing, arbitrary pattern scribing, and/or adjustable pitch scribing, without having to rotate the workpiece.

Systems and methods in accordance with many embodiments provide for laser scribing using simple longitudinal glass movement and multiple laser scanners to scribe workpieces, for example, film-deposited substrates used in some solar cell devices. The workpiece can be moved during scribing, and lasers direct beams to translatable scanners that direct the beams up through the substrate to the film(s) being scribed. The scanners can provide for both latitudinal and longitudinal scribing.

Many embodiments can provide for a shorter beam path from the scribing laser to the workpiece, which may significantly alleviate any beam convergence and stability issues. In many embodiments, a shorter beam path from the scribing laser to the workpiece is realized by having the laser source close to the workpiece. In many embodiments, this beam path is made even shorter by having the laser source move laterally according to the pattern the laser is trying to scribe. Allowing the laser source to be close to the workpiece allows the laser beam path to be minimized, which may help to minimize issues such as beam convergence and stability. In many embodiments, the workpiece moves longitudinally and the laser beam is able to move both laterally and longitudinally via a scanning device, but the laser beam path is still minimized as the laser source moves using a translation mechanism able to laterally translate the laser assemblies relative to the workpiece.

In many embodiments, the translation stage or bed is implemented with separated sections, such as substantially planar sections. In many embodiments, the center section is laterally movable, allowing the center section of the bed to move in conjunction with the laser source and optics as laterally translated by the translation mechanism, allowing a desired pattern to be scribed on the workpiece, while the two end sections of the bed are kept stationary. Such coordinated motion also provides various other advantages as described elsewhere herein. In many embodiments, the translation stage or bed consists of three or more sections that allow the base to be shipped in three or more parts using different packaging levels and assembled on site, making it easier to ship from the manufacturer site to the user site.

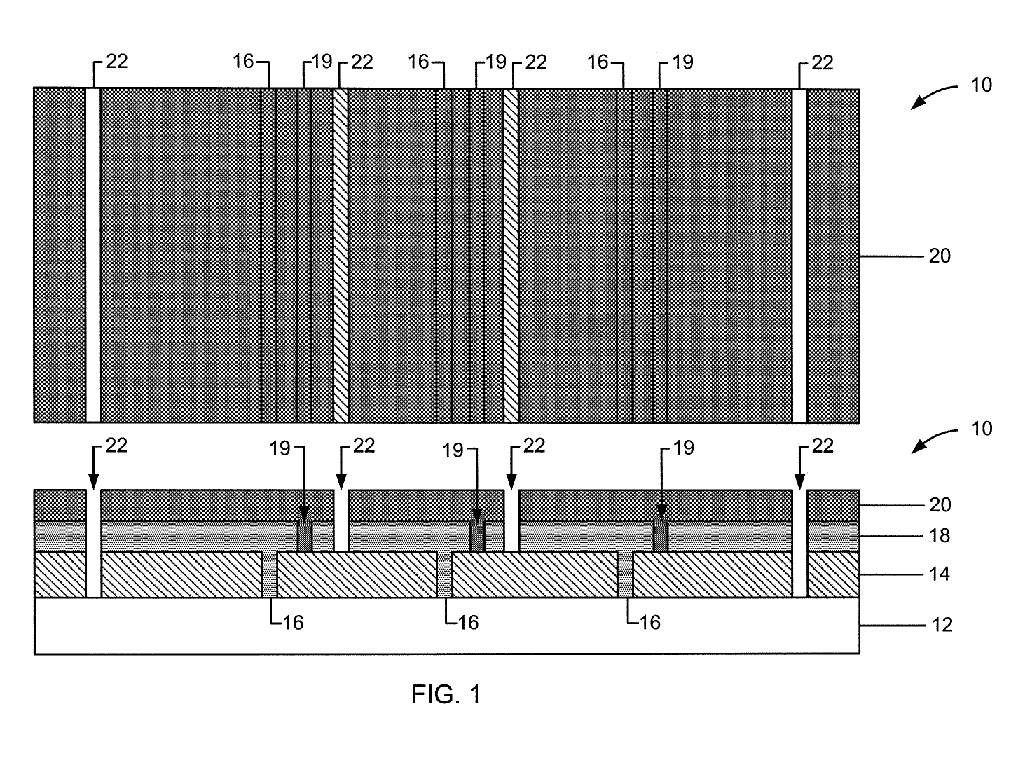

When a solar panel is being formed from a large substrate, for example, a series of laser-scribed lines is typically used within each layer to delineate the individual cells. FIG. 1 illustrates laser-scribed lines within an example assembly 10 used in a thin-film solar cell. During the formation of the assembly 10, a glass substrate 12 has a transparent conductive oxide (TCO) layer 14 deposited thereon. The TCO layer 14 is then separated into isolated regions via laser-scribed P1 lines 16. Next, an amorphous-silicon (a-Si) layer 18 is deposited on top of the TCO layer 14 and within the scribed P1 lines 16. A second set of lines (“P2” lines 19) are then laser scribed in the amorphous-silicon (a-Si) layer 18. A metal-back layer

is then deposited on top of the amorphous-silicon (a-Si) layer 18 and within the scribed P2 lines 19. A third set of lines 22 (“P3” lines) are laser scribed as shown. While much of the area of the resultant assembly constitutes active regions of solar cells of the panel, various regions lying between the P1 16 and P3 22 scribe lines constitute non-active solar-cell area, also known as “the dead zone”.

In order to optimize the efficiency of these solar cell panels, the non-active solar cell area (i.e., the “dead zone”) of these panels should be minimized. To minimize the dead zone, each P3 line 22 should be aligned as close as possible to a corresponding P1 line 16. As will be discussed in more detail below, line sensing optics can be used to adjust the scribing of lines to minimize the dead zone area on an assembly.

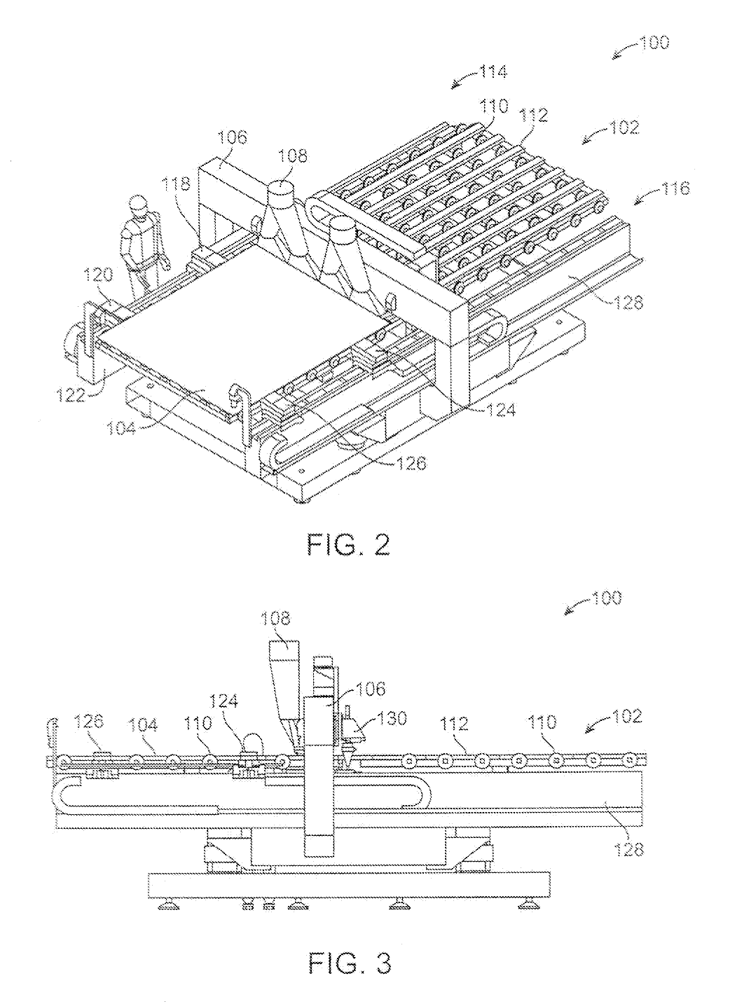

FIG. 2 illustrates an example of a laser-scribing system 100 in accordance with many embodiments. The system includes a translation stage or bed 102, as described herein, which will typically be leveled, for receiving and maneuvering a workpiece 104, for example, a substrate having at least one layer deposited thereon. In one example, the workpiece 104 is able to move along a single directional vector (i.e., for a Y-stage) at various rates (e.g., from 0 m/s to 2 m/s or faster). Typically, the workpiece will be aligned to a fixed orientation with the long axis of the workpiece substantially parallel to the motion of the workpiece in the device, for reasons described elsewhere herein. The alignment can be aided by the use of cameras or imaging devices that acquire marks on the workpiece. In this example, the lasers and optics (shown in subsequent figures) are positioned beneath the workpiece and opposite a bridge 106 holding part of an exhaust mechanism 108 for extracting material ablated or otherwise removed from the substrate during the scribing process. The workpiece 104 typically is loaded onto a first end of the stage 102 with the substrate side down (towards the lasers) and the layered side up (towards the exhaust). The workpiece is initially received onto an array of rollers 110 and can then be supported by a plurality of parallel air bearings 112 for supporting and allowing translation of the workpiece, although other bearing- or translation-type objects can be used to receive and translate the workpiece as known in the art. In this example, the array of rollers all point in a single direction, along the direction of propagation of the substrate, such that the workpiece 104 can be moved back and forth in a longitudinal direction relative to the laser assembly.

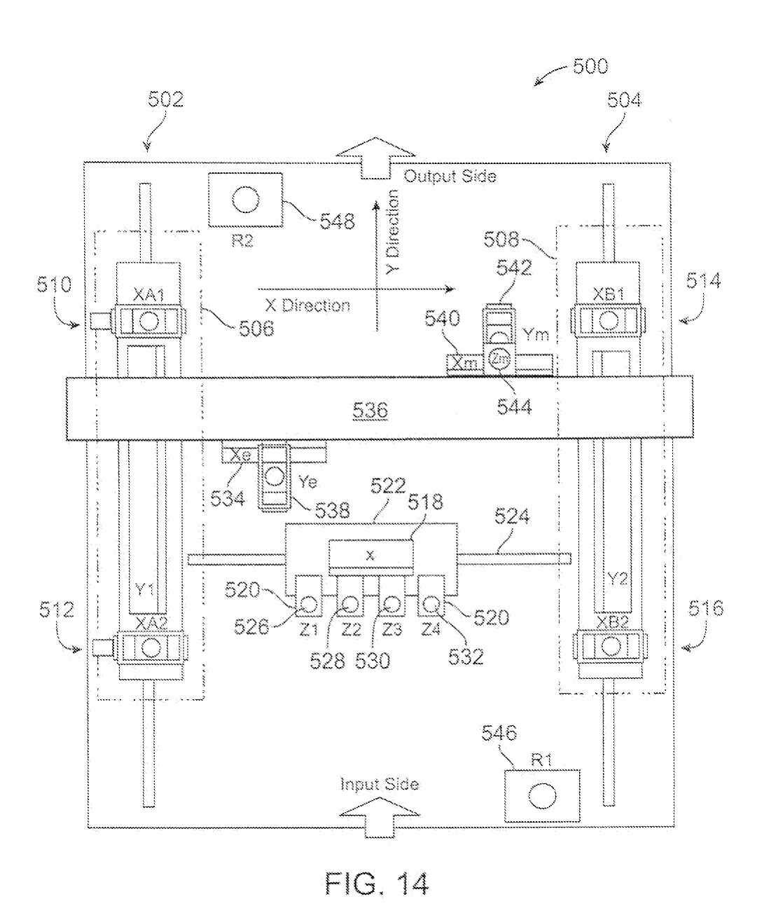

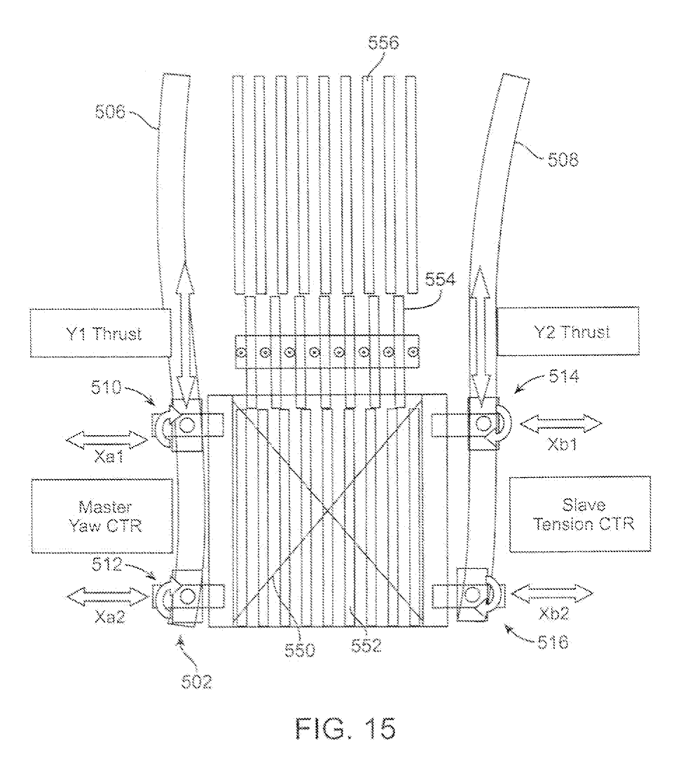

The system 100 includes a controllable drive mechanism for controlling a direction and translation velocity of the workpiece 104 on the stage 102. The controllable drive mechanism includes two Y-direction stages, stage Y1 114 and stage Y2 116, disposed on opposite sides of the workpiece 104. Stage Y1 114 includes two X-direction stages (stage XA1 118 and stage XA2 120) and Y1-stage support 122. Stage Y2 116 includes two X-direction stages (stage XB1 124 and stage XB2 126) and Y2-stage support 128. The four X-direction stages 118, 120, 124, 126 include workpiece grippers for holding the workpiece 104. Each of the Y-direction stages 114, 116 include one or more air bearings, a linear motor, and a position sensing system. As will be described in more detail below with reference to FIGS. 14 and 15, the X-direction stages 118, 120, 124, 126 provide for more accurate workpiece movement by correcting for straightness variations that exist in the Y-direction stage supports 122, 128. The stage 102, bridge 106, and the Y-stage supports 122, 128, can be made out of at least one appropriate material, for example, the Y-stage supports 122, 128 of granite.

The movement of workpiece 104 is also illustrated in the side view of system 100 shown in FIG. 3, where the workpiece 104 moves back and forth along a vector that lies in the plane of the figure. Reference numbers are carried over between figures for somewhat similar elements for purposes of simplicity and explanation, but it should be understood that this should not be interpreted as a limitation on the various embodiments. As the workpiece is translated back and forth on the stage 102 by the Y-direction stages, a scribing area of the laser assembly effectively scribes from near an edge region of the substrate to near an opposite edge region of the substrate. The translation of the workpiece is facilitated in part by the movement of stage Y2 (i.e., by the movement of X-direction stages 124, 126 along the Y2-stage support 128).

In order to ensure that the scribe lines are being formed properly, additional devices can be used. For example, an imaging device can image at least one of the lines after scribing. Further, a beam profiling device 130 can be used to calibrate the beams between processing of substrates or at other appropriate times. In many embodiments where scanners are used, for example, which may drift over time, a beam profiler allows for calibration of the beam and/or adjustment of beam position.

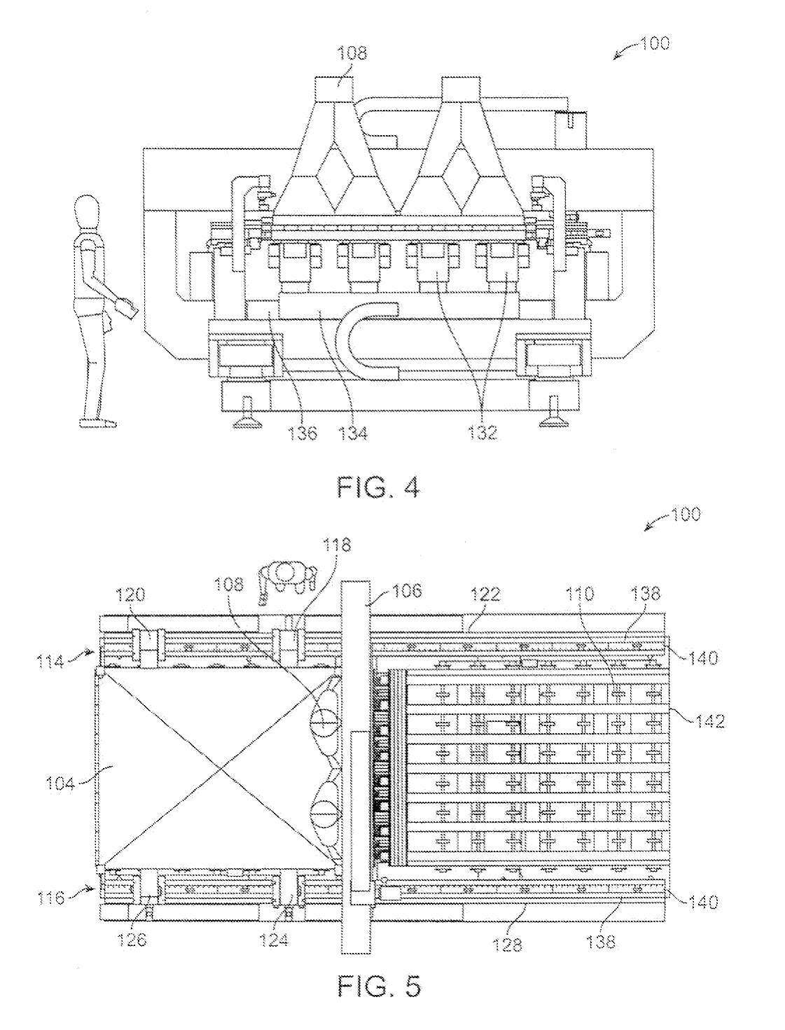

FIG. 4 illustrates an end view of system 100, illustrating a series of laser assemblies 132 used to scribe the layers of the workpiece. While any number of laser assemblies 132 can be employed, in this specific example, there are four laser assemblies 132. Each of the laser assemblies 132 can include a laser device and elements, for example, lenses and other optical elements, needed to focus or otherwise adjust aspects of the laser. The laser device can be any appropriate laser device operable to ablate or otherwise scribe at least one layer of the workpiece, for example, a pulsed solid-state laser. As can be seen, a portion of the exhaust 108 is positioned opposite each laser assembly relative to the workpiece, in order to effectively exhaust material that is ablated or otherwise removed from the workpiece via the respective laser device. In many embodiments, the system is a split-axis system, where the stage 102 translates the workpiece 104 along a longitudinal axis (e.g., right to left in FIG. 3). The lasers and optics can be attached to a translation mechanism able to laterally translate the laser assemblies 132 relative to the workpiece 104 (e.g., right to left in FIG. 4). For example, the laser assemblies can be mounted on a support or platform 134 that is able to translate on a lateral rail 136, or using another translation mechanism, for example, a translation mechanism that may be driven by a controller and servo motor. In one system, the lasers and laser optics all move together laterally on the support 134 along with the center portion of the bed and the exhaust. This allows shifting scan areas laterally, while maintaining a small beam path and keeping the exhaust directly above the portions of the workpiece being ablated by the lasers. In some embodiments, the lasers, optics, center stage portion, and exhaust are all moved together by a single arm, platform, or other mechanism. In other embodiments, different components translate at least some of these components, with the movement being coordinates by a controller for example, as described in U.S. Patent Application No. 61/044,021, (Attorney Docket No. 016301-087200US), filed Apr. 10, 2008, which has been previously incorporated herein by reference (via an above statement).

FIG. 5 illustrates a top view of system 100 showing components of the Y-direction stages 114, 116. Y-direction stage Y1 114 includes X-direction stages XA1 118 and XA2 120, which translate along the Y1-stage support 122. Y-direction stage Y2 116 includes X-direction stages XB1 124 and XB2 126, which translate along the Y2-stage support 128. Each of the Y-direction stages 114, 116 includes a linear motor having a magnetic channel 138 disposed within the top portion of Y-direction stage supports 122, 128. Each of the Y-direction stages 114, 116 also includes a position sensing system, which includes an encoder strip 140 disposed on the respective Y-direction stage support 122, 128. Each of the Y-direction stages 114, 116 includes a reader head for monitoring the position of the Y-direction stage via reading the respective encoder strip 140.

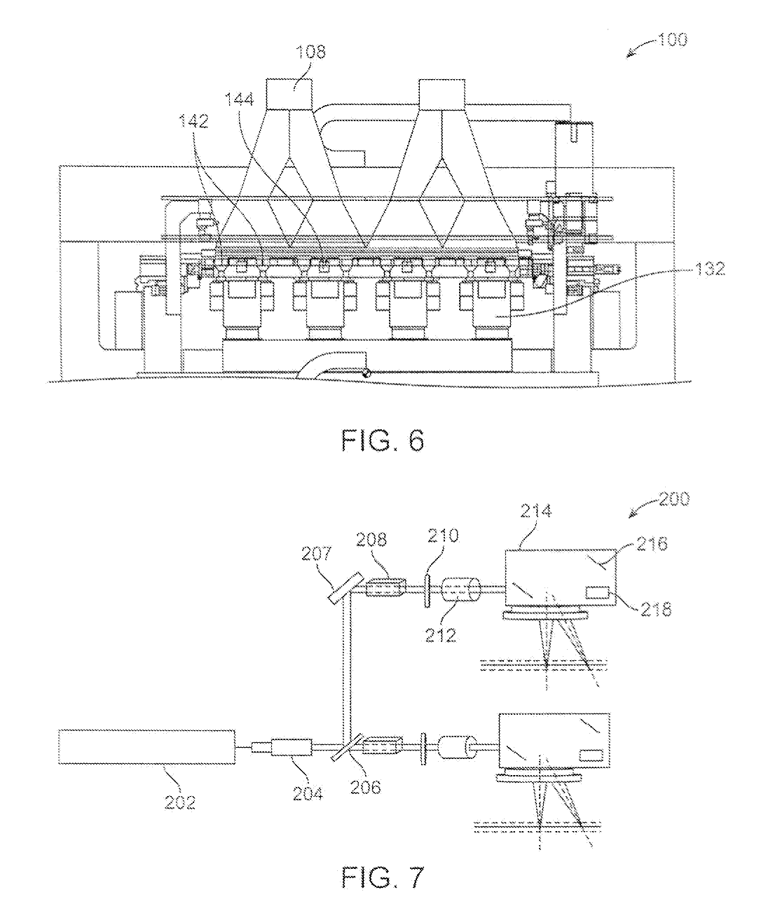

FIG. 6 is a focused view of system 100 showing that each laser device of the system 100 actually produces two effective beams 142 useful for scribing the workpiece. In other embodiments, each laser device can be used to produce any number of effective beams, for example, two, three, or more effective beams. In order to provide the pair of beams, each laser assembly 132 includes at least one beam splitting device. As can be seen, each portion of the exhaust 108 covers a scan field, or an active area, of the pair of beams in this example, although the exhaust could be further broken down to have a separate portion for the scan field of each individual beam. Each beam in this example passes between air bearings of the bed, and the beam position between the air bearings is retained during lateral translation of the moveable center section, lasers, and optics.

Substrate thickness sensors 144 provide data that can be used to adjust heights in the system to maintain proper separation from the substrate due to variations between substrates and/or in a single substrate. For example, each laser can be adjustable in height (e.g., along the z-axis) using a z-stage, motor, and controller, for example. In many embodiments, the system is able to handle 3-5 mm differences in substrate thickness, although many other such adjustments are possible. The z-motors also can be used to adjust the focus of each laser on the substrate by adjusting the vertical position of the laser itself. A desired vertical focus of each laser can be used to selectively ablate one or more layers of the workpiece by concentrating the beam at the desired vertical position or range of vertical positions so as to produce the desired ablation. By adjusting the focus of each laser to local variations of the workpiece, more consistent line widths and spot shapes can be achieved.

FIG. 7 diagrammatically illustrates basic elements of an exemplary laser assembly 200 that can be used in accordance with many embodiments, although it should be understood that additional or other elements can be used as appropriate. In assembly 200, a single laser device 202 generates a beam that is expanded using a beam expander 204 then passed to a beam splitter 206, for example, a partially transmissive mirror, half-silvered mirror, prism assembly, etc., to form first and second beam portions. One or more of the beam portions can be redirected by a mirror 207. In this assembly, each beam portion passes through an attenuating element 208 to attenuate the beam portion, adjusting an intensity or strength of the pulses in that portion, and a shutter 210 to control the shape of each pulse of the beam portion. Each beam portion then also passes through an auto-focusing element 212 to focus the beam portion onto a scan head 214. Each scan head 214 includes at least one element capable of adjusting a position of the beam, for example, a galvanometer scanner useful as a directional deflection mechanism. In many embodiments, this is a rotatable mirror able to adjust the position of the beam along a latitudinal direction, orthogonal to the movement vector of the workpiece, which can allow for adjustment in the position of the beam relative to the workpiece.

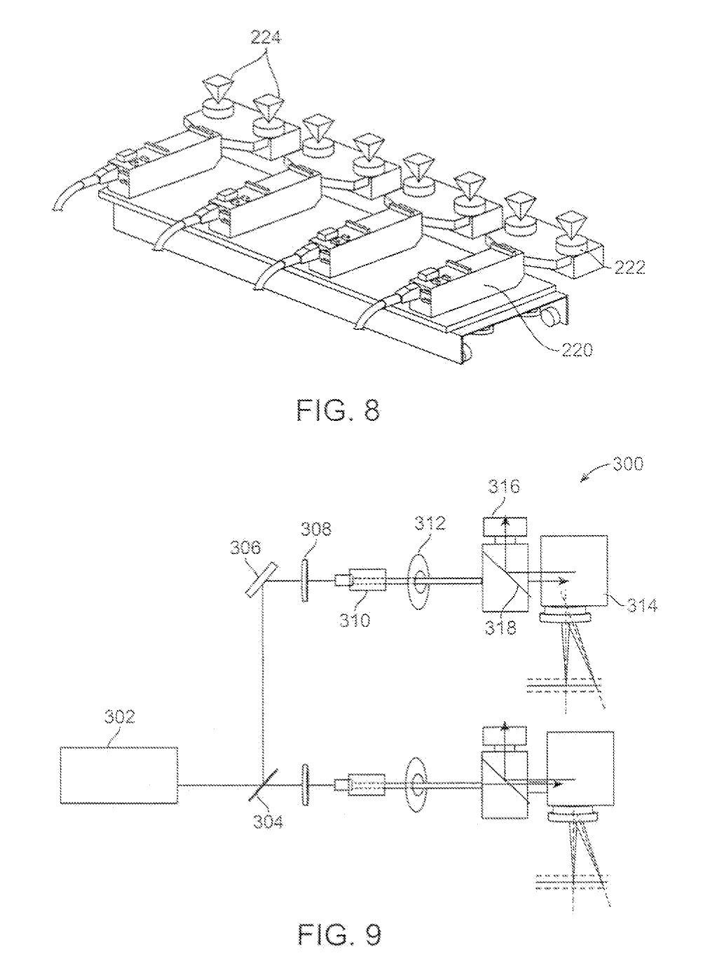

In many embodiments, each scan head 214 includes a pair of rotatable mirrors 216, or at least one element capable of adjusting a position of the laser beam in two dimensions (2D). Each scan head includes at least one drive element 218 operable to receive a control signal to adjust a position of the “spot” of the beam within a scan field and relative to the workpiece. Various spot sizes and scan field sizes can be used. For example, in some embodiments a spot size on the workpiece is on the order of tens of microns within a scan field of approximately 60 mm×60 mm, although various other dimensions and/or combinations of dimensions are possible. While such an approach allows for improved correction of beam position on the workpiece, it can also allow for the creation of patterns or other non-linear scribe features on the workpiece. Further, the ability to scan the beam in two dimensions means that any pattern can be formed on the workpiece via scribing without having to rotate the workpiece. For example, FIG. 8 illustrates a perspective view of example laser assemblies. A pulsed beam from each laser 220 is split along two paths, each being directed to a 2D scan head 222. As shown, the use of a 2D scan head 222 results in a substantially square scan field for each beam, represented by a pyramid 224 exiting each scan head 222. By controlling a size and position of the square scan fields relative to the workpiece, the lasers 220 are able to effectively scribe any location on the substrate while making a minimal number of passes over the substrate. If the positions of the scan fields substantially meet or overlap, the entire surface could be scribed in a single pass of the substrate relative to the laser assemblies.

FIG. 9 diagrammatically illustrates a laser assembly 300, in accordance with many embodiments. The laser assembly 300 is similar to the laser assembly 200 of FIG. 7, but includes two integrated imaging devices for imaging features of the workpiece. The laser assembly 300 includes a laser device 302. The laser device 302 can include various related devices and features. For example the laser device can include an internal power meter for monitoring the power output of the laser. As a further example, the laser device can include an attenuation adjustment, for example, manual attenuation adjustment between two levels (e.g., between 5% and 95%). A beam generated by laser device 302 can be split into first and second beam portions by a beam splitter 304, for example, a partially transmissive mirror, half-silvered mirror, prism assembly, etc. In some embodiments, the beam splitter 304 can be manually adjusted so as to vary the relative portions of the beam generated by laser device 302 that makes up the first and second beam portions (e.g., from 45% to 55% in a particular beam). Each beam portion passes through a shutter 308 to control the shape of each pulse. The shutter 308 can be selected to have a sufficiently fast speed necessary to accomplish a desired shaping of each pulse. For example, in some embodiments the shutter 308 can be selected to have a speed of 50 msec or less. Each beam portion also passes through a collimator 310. Various collimators can be used. For example, a 3-4× up-collimator with plus-or-minus 1 mm manual focus adjustment can be used. Each beam portion also passes through a beam shaping element 312, for example, a beam shaping element with an aperture of 2 mm, which shapes each beam portion prior to being provided to each of the scanners 314, which can be similar to the scanners 214 of FIG. 7. Two imaging devices 316 are integrated with system 300 so as to view the workpiece through scanners 314. Light reflected from features on the workpiece enters each of the scanners 314, where it is redirected by the scanner towards a dichromatic beam splitter 318. Each dichromatic beam splitter 318 redirects the reflected light towards one of the imaging devices 316, for example, a charge-coupled device (CCD) camera or a complementary metal-oxide-semiconductor (CMOS) device. As shown, each of the imaging devices 316 can be integrated using a dichromatic beam splitter 318 so as provide an imaging device view direction that substantially corresponds with the direction along which a separate laser beam portion is provided to each of the scanners 314. Although a range of relative positions can be practiced, an imaging device 316 can be integrated so that the center of its view and the output of the scribing laser 302 point at the same position on a workpiece being targeted by the scanner 314.

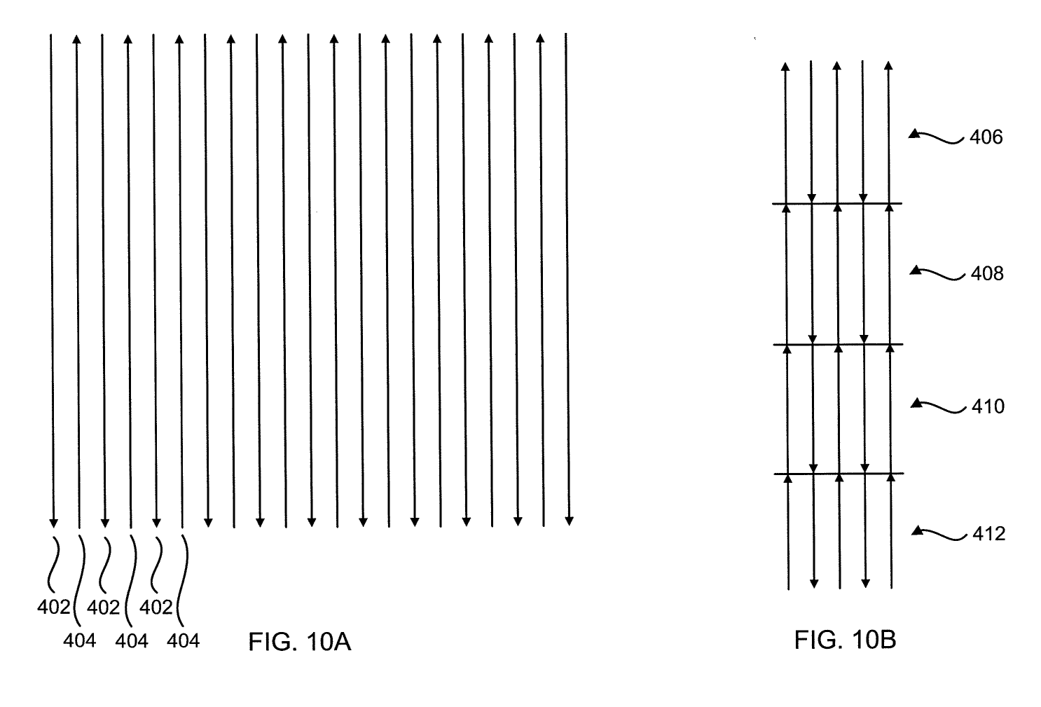

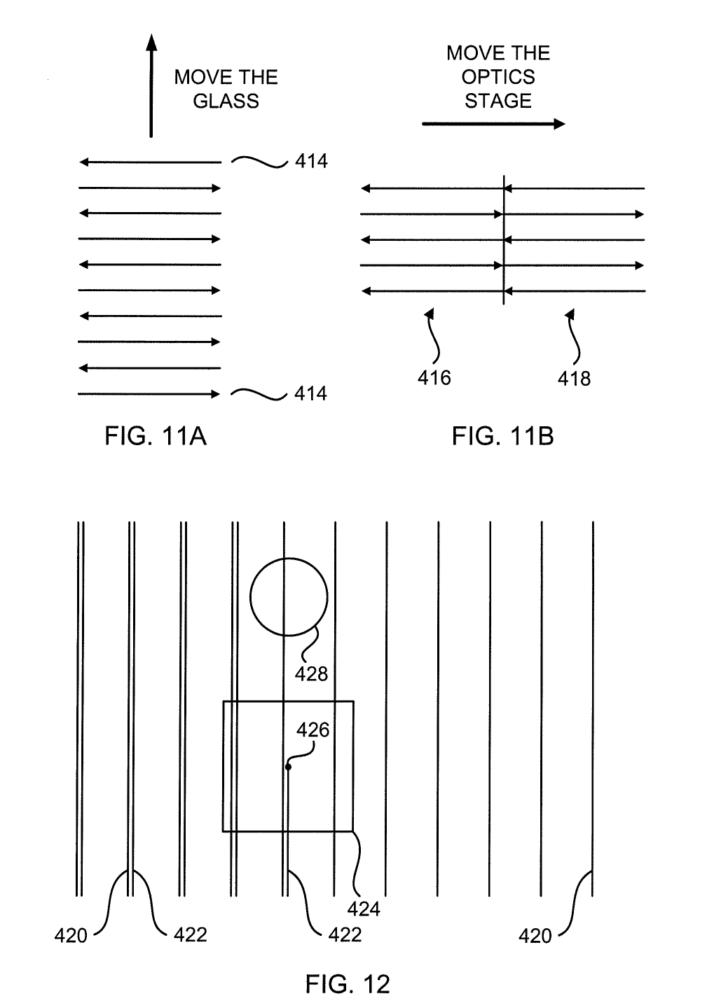

A variety of approaches can be used to laser-scribe lines in different directions using embodiments of the systems and methods disclosed herein. For example, laser-scribe lines having a direction parallel to the movement direction of the workpiece can be formed in a number of ways. FIG. 10A illustrates one such approach, where one or more of the scanners is used to fix the position of one or more of the laser outputs while the workpiece is translated relative to the lasers. Laser-scribe lines 402 can be formed while the glass moves relative to the lasers in a first direction (i.e., from bottom to top in FIG. 10A). The beam position(s) can then be adjusted as the workpiece changes direction. Laser-scribe lines 404 can then be formed while the glass moves relative to the lasers in the opposite direction (i.e., from top to bottom in FIG. 10A). In many embodiments, the glass can move at various rates (e.g., 0 m/sec to 2 m/sec or faster). FIG. 10B illustrates another approach for forming scribe lines having a direction parallel to the movement direction of the workpiece, where the scribe lines are formed in separate blocks 406, 408, 410, 412. With this approach, the workpiece can be moved more slowly, which may introduce less position error. The scribe lines can be “stitched” together to create long scribe lines. One or more scanners can be used to scan the laser output over the workpiece at the desired rate (e.g., 0 m/sec to 2 m/sec or faster), such that no change to laser parameters are required between the two approaches. A number of approaches can also be used to form scribe lines having a direction perpendicular to the movement direction of the workpiece. In one approach illustrated in FIG. 11A, laser-scribe lines 414 can be formed by using the scanners to scan the output of the lasers while the glass is being slowly moved. In another approach that is illustrated in FIG. 11B, the optics stage can be moved with the workpiece held fixed and the scribe lines can be formed in blocks 416, 418 that can be stitched together to form long lines. In both approaches, one or more scanners can be used to scan the laser output over the workpiece at the desired rate, for example, 2 meters per second, and/or such that no change to laser parameters are required between the two approaches.

Line sensing optics can be used to determine location data for one or more previously formed features. Such location data can be used to control the formation of subsequently formed features relative to previously formed features. For example, data indicative of one or more locations on a previously formed P1 line can be used to control the formation of a P2 line relative to the P1 line. Line sensing optics can include a light source and a camera, which detects the light reflected from the workpiece and/or scribe lines.

FIG. 12 illustrates one approach for using line-sensing optics, and shows a set of previously-formed P1 lines 420 and a partially formed set of P2 lines 422, which are being formed closely adjacent to the previously-formed P1 lines 420. A scanner field-of-view 424 and a currently targeted location 426 are shown during the formation of one of the P2 lines 422. A line-sensing optics field-of-view 428 can be used to determine location data for the P1 lines 420, for example, for the P1 line 420 next to which the P2 line 422 being formed is situated. Such location data can be used to more closely control the formation of the P2 line 422 so as to be more tightly spaced with the P1 line 420.

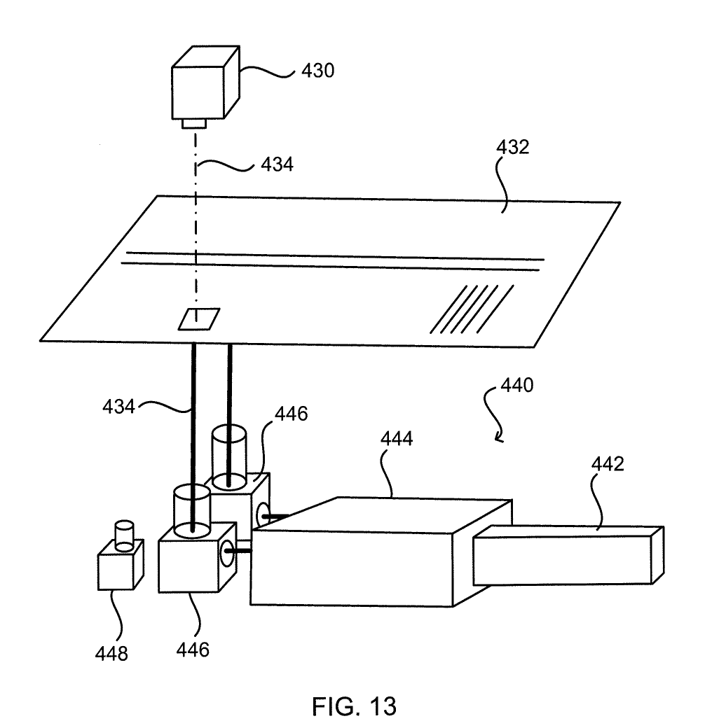

A laser-scribing system can include a number of components useful for controlling the scribing of laser lines on a workpiece. For example, as illustrated in FIG. 13, a beam viewer 430 can be used to measure the position of the output from the laser. Data from the beam viewer 430 can be used for rapid recalibration of the beam position. As illustrated, the beam viewer 430 can be positioned over a workpiece 432 so as to capture the position of a beam 434 as it passes through the workpiece 432. The expected and the actual position of the beam 434 can be compared to calculate a correction, which can provide a highly accurate adjustment for the correction of any drifts that occur. The beam measured can be projected by a laser assembly 440 that includes a laser 442, beam split optics 444, and scanners 446. As discussed above, the laser assembly 440 can be located on an optics gantry (not shown). A power meter (not shown) can also be positioned on the optics gantry for monitoring the laser power incident on the glass. A microscope (not shown) can also be used. A primary function of the microscope is calibration and alignment of the glass. The microscope can also be used to observe the scribe quality and measure the size of ablation spots. A line sensor 448 can also be used to generate location data for previously formed features. The line sensor 448 can be located in a number of locations from which it can view the previously formed features, for example, beneath the workpiece 432 as illustrated.

In accordance with many embodiments, FIG. 14 diagrammatically illustrates a system 500 that includes various stages that can be used to move scribing device components. As will be described in more detail below, the various stages provide for movement of the workpiece, the laser-scribing assemblies, the exhaust assembly and the microscope.

Stages Y1 502, Y2 504 can be used to provide for Y-direction movement of a workpiece during laser scribing. Stages Y1 and Y2 each can include a linear motor and one or more air bearings for y-direction travel along Y-stage supports 506, 508. Each linear motor can include a magnetic channel and coils that ride within the magnetic channel. For example, the magnetic channel can be integrated into Y-stage supports 506, 508. Supports 506, 508 are preferably precisely manufactured so as to be within predetermined straightness requirements. Supports 506, 508 can be made from a suitable material, for example, granite. Stages Y1 and Y2 are the main Y-direction controls for the movement of the workpiece. There is no mechanical connection between the Y1 and Y2 stages when no workpiece is loaded. When a workpiece is loaded, the Y1 stage can be the master and the Y2 stage can be the follower.

Each of stages Y1, Y2 can include a position-sensing system, for example, an encoder strip and a read head. An encoder strip can be mounted to each of supports 506, 508 and read heads can be mounted to moving portions of stages Y1 and Y2, for example, a moving carriage for Y1 and a moving carriage for Y2. Output from the read heads can be processed for controlling the position, speed, and/or acceleration of each of the Y-stages. An example read head is a Renishaw Signum RELM Linear encoder readhead SR0xxA, which can be coupled with Interface unit Si-NN-0040. The SR0xxA is a high resolution analog encoder read head. The Interface unit Si-NN-0040 buffers analog encoder signals and generates 0.5 um digital encoder signals. The read head and interface unit are available from Renishaw Inc., 5277 Trillium Blvd., Hoffman Estates, Ill. 60192.

Stages XA1 510 and XA2 512 are mounted for movement with stage Y1 and provide for finely tuned X-direction control for the workpiece as it is being translated in the Y-direction by the Y stages. Such X-direction control can be used to compensate for straightness deviations of support 506. An external laser measurement system (with straightness and yaw optics/interferometer) can be used during initial calibration to measure straightness and yaw data for the master stage (Y1 stage). The measured data can be used to create error tables, which can be used to supply correction data into a motion controller for use during the Y-direction movement of the workpiece. The XA1, XA2 stages are coupled with the Y1 stage. Stages XA1, XA2 can each include a ball screw stage and be mounted on the Y1 stage with dual-loop control (e.g., rotary and linear encoders) for high accuracy and repeatability. Stages XA1, XA2 can each carry a workpiece gripper module. Each gripper module can include one or more sensors for detecting a position of the gripper module (e.g., open, closed). Each gripper module can also include one or more banking pins for controlling the amount of the workpiece held by the gripper module. Stages XB1 514, XB2 516 are mounted for movement with stage Y2. Stages XB1, XB2 can each include a workpiece gripper module, such as the above described gripper module. Stages XB1, XB2 can include a linear stage that can controlled with an open-loop control system so as to maintain a desired level of tension across a workpiece.

X laser stage 518 can be used to provide for X-direction movement of laser assemblies 520 during laser scribing of a workpiece. X laser stage can include a linear motor and one or more air bearings for travel of a laser assembly support 522 along a support rail 524. Laser assembly support 522 can be precision fabricated from a suitable material, for example, granite. The linear motor can include a magnetic channel integrated with the support rail and coils that ride within the magnetic channel.

Z-direction stages Z1 526, Z2 528, Z3 530, and Z4 532 can be used to adjust the vertical positions of the laser assemblies. Such position adjustment can be used for a variety of purposes, such as those discussed above with reference to FIG. 6.

Xe exhaust stage 534 can be used to provide for X-direction movement of an exhaust assembly during laser scribing of a workpiece. The Xe exhaust stage can include a linear stage mounted to a side (e.g., front side as shown) of a bridge 536. The bridge can be fabricated from a suitable material, for example, granite. A Ye exhaust stage 538 can be used to provide for Y-direction movement of the exhaust assembly. Such Y-direction movement can be used to move the exhaust assembly away from a laser-scribing area so as to allow inspection of the laser-scribing area with a microscope. The Ye exhaust stage can include a linear actuator, for example, a ball screw actuator.

Xm microscope stage 540 can be used to provide for X-direction movement of a microscope. The Xm stage can include a linear stage and can be mounted to a side of the bridge 536, for example, the back side as shown. A Ym microscope stage 542 can include a linear stage and be mounted to the Xm stage. A Zm microscope stage 544 can include a linear stage and be mounted to the Ym stage. The combination of the Xm, Ym, and Zm stages can be used to reposition the microscope to view selected regions of a workpiece.

Roller stages R1 546 and R2 548 can be used to load and unload a workpiece, respectively. The R1, R2 roller stages can be configured to be raised relative to an air bearing bed (not shown) during the loading and unloading sequences. For example, roller stage R1 546 can be in a raised position while a workpiece is being loaded. Roller stage R1 can then be lowered to place the workpiece on the air bearing bed. The workpiece can then be grasped by the gripper modules of stages XA1, XA2, XB1, and XB2. During unloading the sequence can be reversed, such that the workpiece is released from the gripper modules and the roller stage R2 548 can then be raised to lift the workpiece from the air bearing bed.

FIG. 15 depicts an exaggerated view of Y-direction straightness deviations of the Y-stage supports 506, 508 so as to illustrate the X-direction corrections that can be made by using stages XA1 510 and XA2 512 during the Y-direction movement of a workpiece. The X-direction corrections can be determined such that a workpiece 550 travels with less straightness deviations than that of the Y-stage supports 506, 508. For example, the Y-direction straightness deviations (e.g., X-direction deviations from a true Y-direction oriented straight line) of the Y1 stage support 506 can be measured along the length of travel of the Y1 stage 502. The measured deviations can be used to control stages XA1 and XA2 such that the workpiece 550 is constrained to travel with less deviation from a true Y-direction oriented straight line than that of the Y1 stage support. As discussed above, stages XB1 514 and XB2 516 can be controlled with an open-loop control system so as to maintain a desired level of tension across the workpiece 550.

During the Y-direction movement of the workpiece, the workpiece is supported by air bearing beds 552, 554, and 556. Central air bearing bed 554 can be coupled with the X laser stage 518 so as to maintain their relative positions, which provides gaps between the sections of the air bearing bed 554 through which the laser pulses can pass.

The above described systems can be used to produce substrate motion that is accurately controlled within certain boundaries. For example, a workpiece can be accelerated and decelerated at various rates (e.g., at up to 0.8 G or more). The workpiece can be scribed while traveling at an instantaneous velocity that is matched with the instantaneous firing rate of the scribing lasers. For example, the workpiece can be scribed while traveling at any substantially constant velocity that is matched with a constant firing rate of the scribing lasers (e.g. slower than, equal to, or faster than 2.0 m/sec). The straightness and yaw of the workpiece while being translated during scribing can also be maintained within set boundaries. In many embodiments, the straightness and yaw can be controlled within ±3 μm straightness and ±0.5 arc sec.

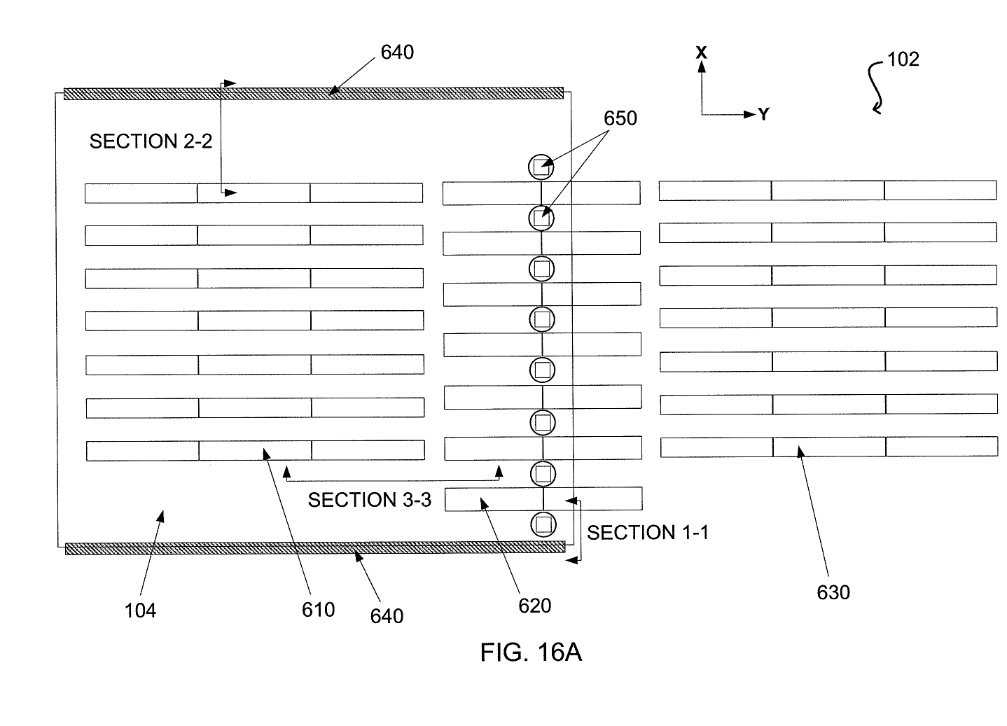

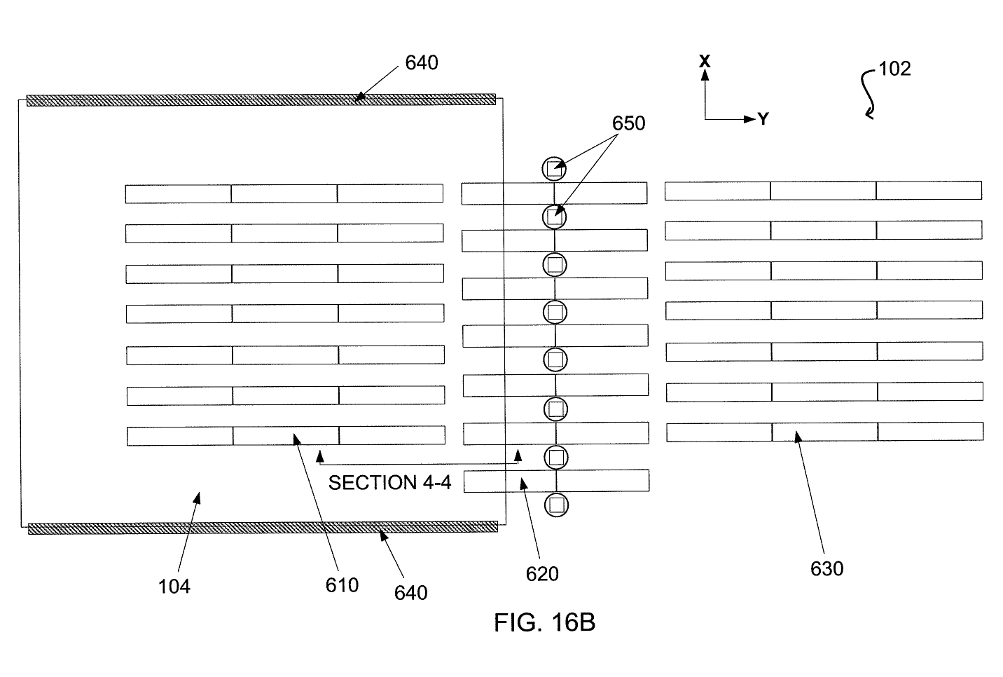

FIGS. 16A and 16B diagrammatically illustrate top views of a “three section” translation stage or bed in accordance with many embodiments. In this “three section” stage, the center section 620 is laterally movable (up and down in the figure) and has gaps, such as may be between air bearings or other support members, while the two end sections (610 and 630) are kept stationary. The gaps in the center section 620 are used to allow the laser beams to pass through, as well as to reduce the weight of the bed. A workpiece 104 can be loaded onto a first end 610 of the translation stage 102 with the substrate side down (towards the lasers) and the layered side up (towards the exhaust). In many embodiments, the laser beams enter the workpiece from the substrate side, the lasers are positioned beneath the workpiece and opposite the bridge 106 holding part of the exhaust mechanism 108 for extracting material ablated or otherwise removed from the substrate during the scribing process. Gaps or holes formed in the movable center section 620 are able to move laterally together with the laser beams during scribing so as to allow the laser beams to pass through. In many embodiments, a scan head can adjust the scribing laser beam to any spot within a scan field 650. In many embodiments, these gaps must be at least large enough to accommodate the scan field of the laser beam. If for example, the scan field of a laser beam covers a 60 mm×60 mm square, then the gap can be about 60 mm wide or more (or less, depending upon the distance of the gap to the workpiece and the scan angle range of the scanner). In FIGS. 16A and 16B, there are eight laser beams, so seven rectangular strips are used to provide the six gaps and two openings (at the outer edges of the center section) needed. In some embodiments, these rectangular strips might measure 1100 mm×200 mm. Additional strips also could be used outside the two external laser beams, and in some embodiments fewer strips can be used where more than one laser can pass through a gap, with the number of strips needed depending on the amount and/or type of support needed for the workpiece.

In many embodiments, the workpiece 104 is loaded onto a first end section 610 and the center section 620 of the three section stage. An array of rollers 110 residing between the seven rectangular strips of first end section 610 moves the workpiece 104 into “position” (i.e., the workpiece 104 sits on top of both the first end section 610 and the center section 620, as shown in FIG. 6A). After the workpiece 104 has been moved into “position”, the rollers drop down and air bearings take over supporting the workpiece 104 when the workpiece is on either end section (610 and 630) and the center section 620. In many embodiments, the initial “position” of the workpiece 104 (i.e., after the rollers have dropped down) is shown in FIG. 6B. Here, the workpiece 104 still sits on top of both the first end section 610 and the center section 620, but now the scribing laser beam outputs are left uncovered. Movement of the workpiece 104 on the stage 102 along the longitudinal or Y-direction (right to left in the figure) is realized using clamps 640, which hold onto opposing edges of the workpiece 104 (as shown in FIGS. 16A and 16B). In many embodiments, the workpiece 104 does not move along the X-direction (top to bottom in the figure), because movement along the X-direction can be handled solely by the moving lasers and optics. In many embodiments, the workpiece 104 also can move along the X-direction (top to bottom in the figure), but movement along the X-direction is handled primarily by the moving lasers and optics.

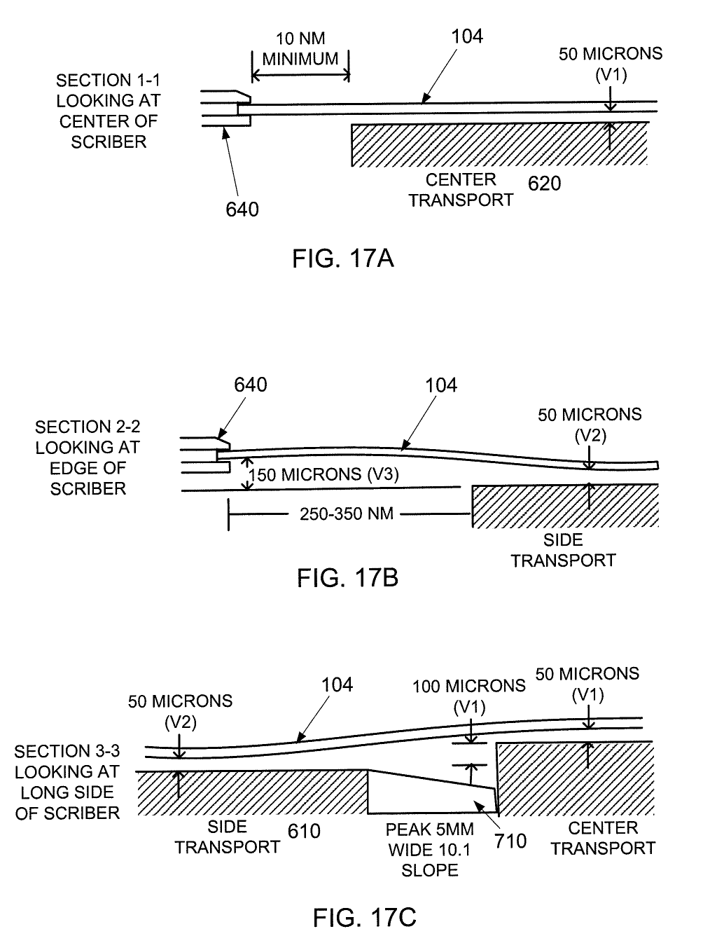

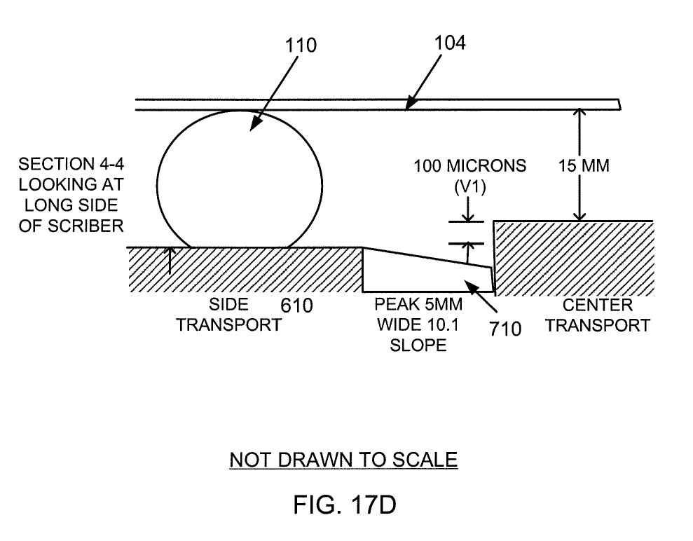

FIGS. 17A-17D illustrate the height differences of the workpiece 104, various stage sections, the clamp 640, and the array of rollers 110 as seen through different cross sectional views of the “three section” translation stage (that was shown in FIGS. 16A and 16B).

FIG. 17A shows a height difference between the clamp 640 and the center section 620. In some embodiments, the clamp 640 will be located at a nominal height of approximately 50 μm above the center section 620, which is close to its air gap, although different systems and applications can utilize difference heights. The workpiece 104 can be supported by air bearings over the center section 620 and both end sections (610 and 630), which can be adjusted to result in a nominal air gap of approximately 50 μm for all three stage sections.

In many embodiments, anticipated sag of the workpiece between clamps 640 can be compensated for by having a slight drop in elevation between the center section 620 and each of the end sections 610, 630. For example, FIG. 17B shows that according to some embodiments the clamp 640 is 150 μm higher than the first end section 610, because the first end section 610 will be lowered by at least 100 μm relative to the center stage 620 in these embodiments to allow for the anticipated sag in the workpiece due to factors such as weight and non-flatness. This 100 μm height difference can be dependent on the tolerance of the substrate used for the workpiece 104. One advantageous feature of such a design is that the workpiece is always at least partially over the center section 620, and the leading edge of the workpiece can only move from a higher height to a lower height as the glass substrate moves between end sections. If the stage portions were at approximately the same height, a slight bend or variation in the workpiece could cause the leading edge of the workpiece to catch an edge of one of the sections of the bed as the workpiece translates from one section to the other, which could result in chipping, cracking, or otherwise damaging the workpiece. A bend in a glass substrate, for example, is estimated at less than 100 μm per 100 mm, which under normal conditions produces negligible stresses. FIG. 17C shows that, in some embodiments, a wedge 710 (with for example a 5 mm wide, 10:1 slope) may be used at the edge of side stage 610 in the event that the non-flatness of the glass substrate exceeds the 100 μm per 100 mm estimate. This wedge 710 can prevent the chipping or shattering of the glass substrate, and is easily replaceable in case the glass substrate scours it.

FIG. 17D shows the height of workpiece 104 over a portion of the three section stage as workpiece 104 is being moved into “position” by the array of rollers 110 residing between the seven rectangular strips of first end section 610 in accordance with some embodiments. In the example shown, this height is 15 mm, which is more than enough distance to prevent the leading edge of the workpiece 104 from catching an edge of one of the sections of the bed as the workpiece 104 translates from one section to the other. After the workpiece 104 has been moved into “position”, the rollers 110 drop down and air bearings take over supporting the workpiece 104 as shown in FIG. 17C.

Since the two end sections 610, 630 are substantially level with each other, all the above measurements and descriptions for the first end section 610 will apply equally to the second end section 630.

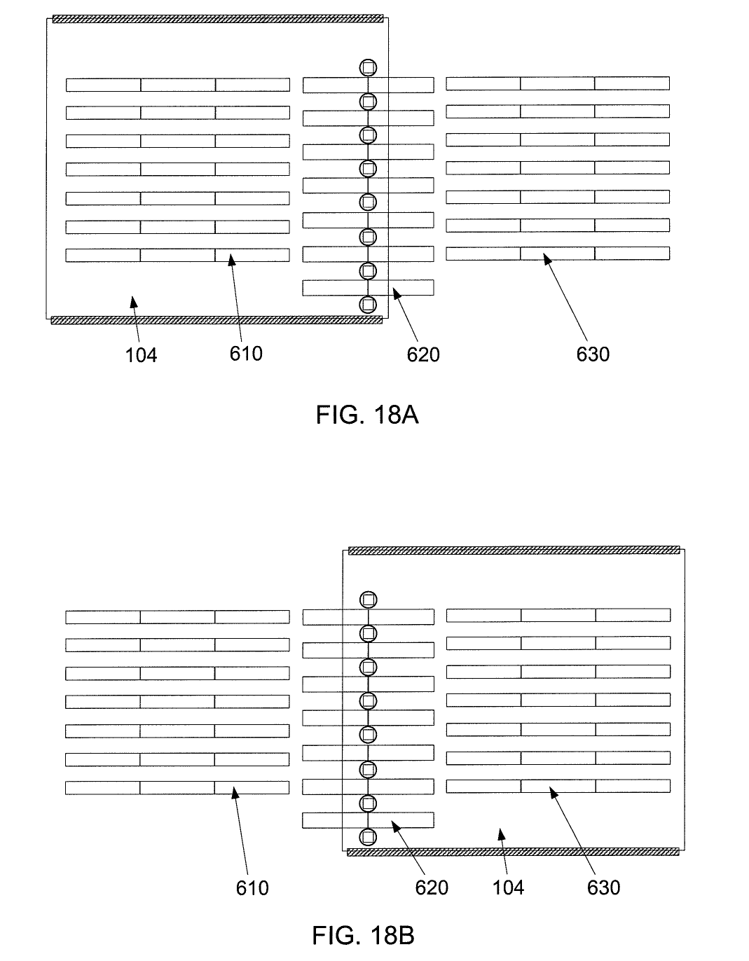

In accordance with many embodiments, FIGS. 18A-18B show that a portion of the workpiece 104 can always overlies a portion of the center section 620, and the leading edge of the workpiece as it translates can only move from high to low as the glass substrate moves from center to end sections. For example, in FIG. 18A, the workpiece 104 sits on both the first end section 610 and the center section 620. During the scribing process, workpiece 104 may be moved along the Y-direction onto the second end section 630. When this occurs, positioning the center section 620 slightly higher than the second end section 630 can prevent chipping of the leading (right in the figure) edge of the workpiece 104. Similarly, if the workpiece 104 sits on both the center section 620 and the second end section 630 (as shown in FIG. 8B), positioning the center section 620 slightly higher than the first end section 610 will prevent chipping of the leading edge (left in the figure) of the workpiece 104 when the workpiece 104 is moved onto the first end section 610. FIGS. 18A and 18B show the extreme positions of the workpiece 104 over the stage 102 along the Y-direction, so it can be seen that a part of the workpiece 104 will always sit on top of the center section 620. This ensures that the workpiece 104 will always be moving from a higher section to a lower section, so no chipping of edges may occur.

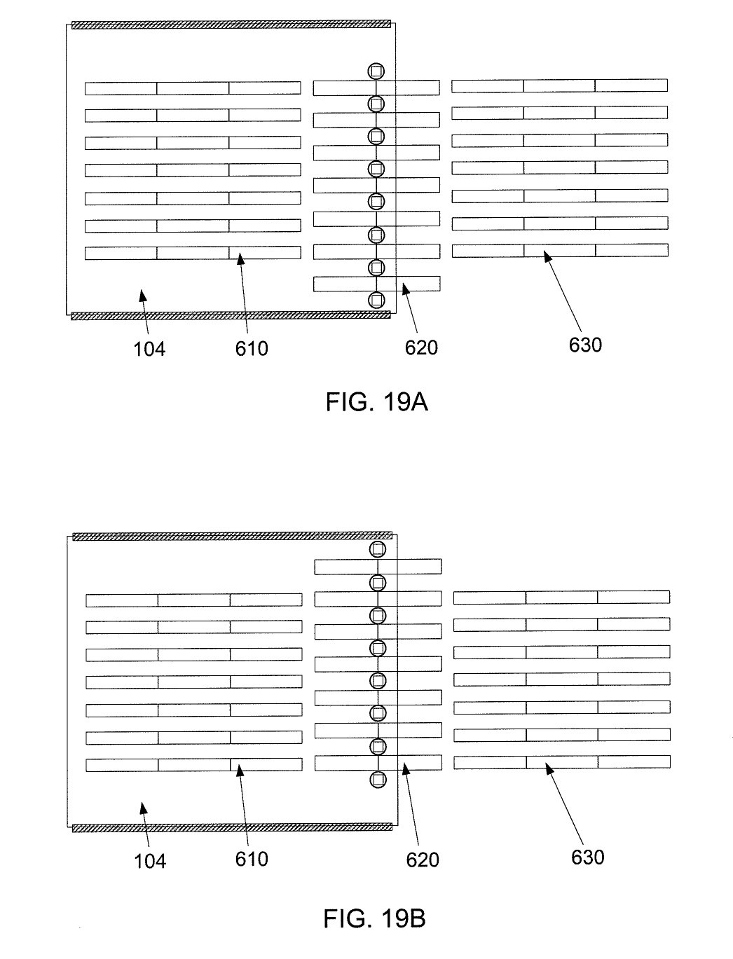

FIGS. 19A and 19B illustrate the extreme lateral positions of the movable center section 620 of the translation stage relative to the workpiece 104 in accordance with many embodiments. FIG. 19A shows that the top edge (in the figure) of the center section 620 lines up with the top edges of the end sections 610, 630 when the center section 620 is moved laterally to its extreme bottom position along the X-direction. FIG. 19B shows that the bottom edge (in the figure) of the center section 620 lines up with the bottom edges of the end sections 610, 630 when the center section 620 is moved laterally to its extreme top position along the X-direction. Again, these configurations may help prevent chipping of the workpiece edge when the workpiece is moved from the center section unto the side section. If the edge of the side section had been configured to extend beyond the edge of the center section, then sagging or non-flatness of the workpiece between the edge of the center section and the clamp could potentially be lower than this extending side section and cause chipping.

It is understood that the examples and embodiments described herein are for illustrative purposes and that various modifications or changes in light thereof will be suggested to a person skilled in the art and are to be included within the spirit and purview of this application and the scope of the appended claims. Numerous different combinations are possible, and such combinations are considered to be part of the present invention.

What is claimed is:

1. A system for scribing a workpiece, comprising:
a laser operable to generate output able to remove material from at least a portion of the workpiece;
a scanning device operable to control a position of the output from the laser;
a translation stage operable to support the workpiece and move the workpiece along a longitudinal translation vector with respect to the scanning device, the translation stage including at least one stationary section and a lateral translation section; and
a lateral translation mechanism operable to laterally translate the scanning device,
wherein the lateral translation section of the translation stage and the scanning device are able to move in a coordinated lateral motion in order to scribe patterns in two dimensions on the workpiece without rotating the workpiece.

2. The system of claim 1, wherein the lateral translation mechanism comprises a laser stage operable to reposition the scanning device laterally relative to the longitudinal translation vector.

3. The system of claim 1, wherein the scanning device is operable to control the position of the output from the laser in two dimensions.

4. The system of claim 1, further comprising additional lasers operable to generate output able to concurrently remove material from additional portions of the workpiece.

5. The system of claim 1, wherein the workpiece comprises a substrate and at least one layer used for forming a solar cell, and wherein the laser is able to remove material from the at least one layer.

6. The system of claim 1, further comprising a beam profiling device for measuring a position or an attribute of the output from the laser.

7. The system of claim 1, further comprising a substrate thickness sensor for determining a thickness of the workpiece, and wherein a focus point of the laser is able to be adjusted in response to the determined thickness.

8. The system of claim 1, further comprising an exhaust mechanism for extracting material ablated or otherwise removed from the workpiece during the scribing process.

9. The system of claim 1, further comprising a power meter for measuring the laser power incident on the workpiece.

10. The system of claim 1, further comprising an imaging device for capturing an image of a previously formed workpiece feature.

11. The system of claim 1, wherein the translation stage comprises a stage that can be controlled so as to reduce deviations in workpiece travel path straightness and yaw as the workpiece is moved along the translation vector.

12. The system of claim 11, comprising a plurality of stages that can be controlled so as to reduce deviations in workpiece travel path straightness and yaw as the workpiece is moved along the translation vector.

13. The system of claim 1, wherein the translation stage comprises a position sensing system.

14. A translation stage operable to support a workpiece during laser scribing, comprising:
a base section; and
a bed supported by the base section, the bed comprising a translatable central section configured to translate laterally with respect to the base section, and the translatable central section comprising at least one gap to allow a laser beam to pass through,
wherein the translatable central section is positioned higher than a remaining portion of the bed such that any workpiece translated longitudinally on the bed will not damage a leading edge of the workpiece when translating from the translatable central section, at least a portion of the workpiece remaining on the translatable central section during longitudinal translation.

15. The translation stage of claim 14, wherein the bed further comprises first and second end sections disposed adjacent to opposite sides of the translatable central section.

16. The translation stage of claim 15, wherein the translatable central section is operable to translate laterally during longitudinal translation of the workpiece.

17. A laser-scribing system, comprising:
a base section;
a bed supported by the base section, the bed comprising a translatable central section configured to translate laterally with respect to the base section, the translatable central section comprising at least one gap to allow a laser beam to pass through;
a laser generating the laser beam, the laser beam configured to be directed through the gap;
a first driving mechanism operable to move a workpiece longitudinally along the bed; and
a second driving mechanism operable to laterally translate the laser and the translatable central section in order to scribe a pattern on the workpiece.

18. The laser-scribing system of claim 17, wherein the second driving mechanism is further operable to laterally translate optics for the laser with the laser and movable section.

19. The laser-scribing system of claim 17, further comprising:
an exhaust mechanism positioned opposite the laser relative to a workpiece on the bed,
wherein the second driving mechanism is further operable to laterally translate the exhaust mechanism with the laser and translatable central section.

20. The laser-scribing system of claim 17, wherein the translatable central section is positioned higher than a remaining portion of the bed such that any workpiece longitudinally translated on the bed will not damage a leading edge of the workpiece, at least a portion of the workpiece remaining on the translatable central section during longitudinal translation.
